(19) United States
(12) Patent Application Publication
(10) Pub. No.: US 2015/0201024 A1
(43) Pub. Date: Jul. 16, 2015

(54) SYSTEM AND METHOD FOR ESTABLISHING A SIP SHARED CONTROL CHANNEL IN MULTIPLE DEVICE ENVIRONMENTS

(71) Applicant: AVAYA, INC., BASKING RIDGE, NJ (US)

(72) Inventors: Mehmet Balasaygun, Freehold, NJ (US); Sandy Abramson, Freehold, NJ (US); Tibor Lukac, Superior, CO (US)

(73) Assignee: AVAYA, INC., BASKING RIDGE, NJ (US)

(21) Appl. No.: 14/154,412

(22) Filed: Jan. 14, 2014

(51) Int. Cl. H04L 29/08

(52) U.S. Cl. CPC H04L 67/14

(57) ABSTRACT

Disclosed is a system and method for creation of a SIP session between a controlling endpoint and a controlled endpoint. The SIP shared control mechanism sets up a first party control channel between a softclient acting as a CTI application and a controlled endpoint. The use of labels associated with multiple controlled endpoints associated with a user are utilized.

### FIELD OF THE INVENTION

The field of the invention relates to creation of a SIP session between a controlling endpoint and a controlled endpoint.

### BACKGROUND OF THE INVENTION

SIP shared control allows creation of an SIP session between a controlling softclient and a controlled endpoint, such as a telecommunications terminal or telephone, for the purposes of exchanging control messages between the controlling application and the controlled endpoint. The SIP shared control mechanism sets up a first party control channel between a softclient acting as a CTI application and a controlled endpoint. The shared-control session setup depends on the controlling application's ability to identify the SIP contact address of a controlled endpoint.

### SUMMARY OF THE INVENTION

An embodiment of the invention may therefore comprise a method for establishing a session initiation protocol shared control channel between a first endpoint and a plurality of second endpoints associated with a user, the method comprising providing a label and shared control support information corresponding to each of the plurality of second endpoints in a Contact header of a REGISTER message to a session initiation protocol registrar, saving each of the labels and shared control support information in association with a registered contact address of the second endpoint, via the first endpoint, reading each of the labels and shared control support information from a registration event NOTIFY message, and creating a shared control session and presenting the labels of the plurality of second endpoints to the user enabling the user to select one of the plurality of endpoints.

An embodiment of the invention may further comprise a method for establishing a session initiation protocol shared control channel between a first endpoint and a plurality of second endpoints associated with a user, the method comprising sending a shared control INVITE request with a Request-URI set to an address of record of a user, the INVITE request comprising an indication of a desired protocol for the shared control session, by a proxy server, receiving said INVITE request, by the proxy server, determining a list of registered contacts associated with the address of record, by the proxy server, selecting from said list one or more of the contacts that support indicated shared control protocol, and by the proxy server, forking the INVITE request to the selected contacts.

An embodiment of the invention may further comprise a method for establishing a session initiation protocol shared control channel between a controlling application and an endpoint, the endpoint comprising one of a plurality of controllable devices, the method comprising at the controlling application, receiving a session initiation protocol registration event notification, at the controlling application, detecting which or one or more registered controllable devices are compatible for a shared control session, sending a separate INVITE request for each controllable device that is deemed compatible, and at the endpoint, enabling control by a user of the endpoint

An embodiment of the invention may further comprise a system for establishing a session initiation protocol shared control channel, the system comprising a controlling endpoint, and a plurality of controlled endpoints associated with an end user, wherein the controlling endpoint is enabled to subscribe to a registration event package, read labels corresponding to the plurality of controlled endpoints from a registration event NOTIFY message, and present the labels to the end user in connection with a shared control SIP session.

### BRIEF DESCRIPTION OF THE DRAWINGS

FIG. 1 shows a method of providing for controllable devices through SIP shared control mechanism.

FIG. 2 shows controlling endpoint and multiple controllable endpoint interaction.

FIG. 3 shows controlling endpoint and single controllable endpoint interaction.

### DETAILED DESCRIPTION OF THE EMBODIMENTS

SIP shared control allows creation of an SIP session between a controlling softclient and a controlled endpoint, such as a telecommunications terminal or telephone, for the purposes of exchanging control messages between the controlling application and the controlled endpoint. The SIP shared control mechanism sets up a first party control channel between a softclient acting as a CTI application and a controlled endpoint. CTI is Computer Telephony Integration. In CTI allows interactions on a telephone and a computer to be integrated and coordinated. CTI may generally be used to describe desktop-based interactions for aiding users and increasing efficiency. However, it is understood that CTI may also refer to server-based functionality such as automatic call routing.

The shared-control session setup depends on the controlling application's ability to identify the SIP contact address of a controlled endpoint. Those skilled in the art will understand the application of SIP shared control session establishment in embodiments of this invention. Further, those skilled in the art will understand how a SIP shared control session is established.

It is understood that SIP is Session Initiation Protocol. SIP is used to identify, locate, and enjoin parties who want to communicate using any peer-to-peer media type. It is understood that SIP does not transport the media itself. The transportation of media is handled by codecs within the communications programs or devices. SIP builds on a number of existing communications protocols. SIP is a signaling communications protocol used for controlling multimedia communication sessions such as voice and video calls over Internet Protocol (IP) networks. The protocol defines the messages that are sent between peers which govern establishment, termination and other essential elements of a call. SIP can be used for creating, modifying and terminating sessions consisting of one or several media streams. SIP can be used for two-party (unicast) or multiparty (multicast) sessions. Other SIP applications include video conferencing, streaming multimedia distribution, instant messaging, presence information, file transfer, fax over IP and online games. SIP works in conjunction with several other application layer protocols that identify and carry the session media. Media identification and negotiation is achieved with the Session Description Protocol (SDP). For the transmission of media streams (voice, video) SIP typically employs the Real-time Transport Protocol (RTP) or Secure Real-time Transport Protocol (SRTP). For secure transmissions of SIP messages, the protocol may be encrypted with Transport Layer Security (TLS).

Multiple Device Access (MDA) is a feature that allows a user to have multiple SIP endpoints registered on behalf of a user. SIP can make call routing decisions based on presence information by enabling users to inform others of their status, availability, and how they can be contacted—before a communication session begins. A user can communicate status and availability to others through multiple devices such as IP phones, mobile phones, softphones, instant messaging, pagers, video conference, e-mail, wireless devices and TDM phones connected to an intelligent IP PBX. SIP can map the unique addresses of a user's multiple devices and services to a communication domain, and then link all the user agents to a user's single AOR for that domain. A user may have a mix of controllable devices (e.g., telephones) and controlling applications (e.g., softclients) that can be used to control the user's devices through set up of control channel(s) over SIP. When the user has multiple shared controllable endpoints, there is an endpoint identification issue when a controlling application is used to control a particular controllable endpoint. Specifically, a controlling application, a softclient, does not have a way of determining which of the MDA devices to create a shared control session with if there are several registered active endpoints. It is understood that while in general a single controllable application may be paired with a single controlled device, this is not a limitation of the described invention. A single controlling application of a user may be used to control multiple devices of a user. As such, it is understood that a one-to-one pairing is not a limitation of the invention as described in that the identification of a controllable device in a one-to-many pairing scenario is also described by and included in the description of the invention.

For example, a user may have a telephone at home and another telephone in an office. This may be an SIP telephone in the home that is remotely connected to the enterprise telephony network as well as a SIP telephone in the office. A user may additionally have a softclient application (for example, Avaya One-X Communicator application) running on a PC that the user may transport between their office and home office. The softclient may provide different modes of operations. For example, the softclient application may be started to directly terminate IP-based media packets (VoIP and video/IP). In other cases, the softclient may be started to pair up with a controllable device to establish a shared control session. When the user with two telephones (home office and office as described herein) chooses to start a softclient in shared control mode, the softclient application will detect two controllable devices registered on behalf of the user. This will be the home phone and the office phone. One of the phones can be used in the shared control session. In an embodiment of the invention, a user is enabled to select the device with which the user would like to create a shared control session. As described herein in the description, it is understood that an embodiment may include a softclient application which can establish separate concurrent control sessions with multiple controlled devices. The invention is not limited to a one-to-one association but includes a one-to-many association between a controlling application and controlled devices.

The entry of display names in a SIP REGISTER request in accordance with RFC 3261, dated June 2002 may be utilized. RFC 3261 is hereby incorporated in its entirety. The notification of user friendly display names in registration event package in accordance with RFC 3680 is hereby incorporated in its entirety. Display names are described in RFC 2822 which is hereby incorporated in its entirety. In an embodiment of the invention, the usage of the above mentioned RFC mechanisms is provided.

Embodiments of the invention provide a system and method that enables an end user to create a control association between two or more endpoints registered with the user's SIP address-of-record (AOR). Further, embodiments of the invention do not require media server for establishing a media link between a first and a second endpoint. Further, embodiments of the invention do not require a SIP Registrar which in effect is a server in the middle that keeps track of SIP registrations of multiple endpoints (telephones or softclients) that are associated with the same user (AOR).

In an embodiment of the invention, each application or device that is controllable through SIP shared control mechanism will prompt a user for entry of a label. The label is user friendly since the user gets to pick it and will identify the device in a user preference manner. For example, the user preferred label may be “Home phone”, or “Office phone” depending on how the user wants to identify the phone. The controllable endpoint provides this user preferred label in the display name portion of a Contact header of the REGISTER message that it sends to register with an SIP registrar. A registrar is a SIP server that typically challenges incoming registration requests and upon receipt of successful challenge responses will record the SIP contact address of the registering SIP endpoint along with the registering user's AOR. Accordingly the SIP server accepts REGISTER requests and places the information it receives in those requests into a location service for the domain it handles. That information may include: (a) a user friendly label; an endpoint's indication that it can support SIP based shared control mechanisms; and (c) the shared control protocol that it is capable of supporting. The location service links one or more IP addresses to the SIP URI (uniform resource identifier) of the registering agent. The URI uses the sip: scheme, although other protocol schemes are possible, such as “tel:”. More than one user agent can register at the same URI, with the result that all registered user agents receive the calls to the URI. SIP registrars are logical elements, and are commonly co-located with SIP proxies. But it is also possible and often good for network scalability to place this location service with a redirect server.

The controllable endpoint providing the user preferred label in the display name portion of the Contact header of the REGISTER message it sends to register with the Registrar allows for the SIP shared control mechanism to properly work in an environment where the user has multiple controllable endpoints, such as multiple telephones. Without it, it is more difficult for the end user to uniquely identify a given phone among multiple devices that are simultaneously registered on behalf of the user.

When the Registrar receives a REGISTER request and the REGISTER request includes a user preferred display name in the Contact header, the display name information is saved along with the registered contact address. In addition, the shared control support and the shared control protocol indications are also saved along with the registered contact address as previously indicated. A sample SIP Contact address carrying endpoint's user friendly label and shared control capability is shown below:

Contact: “Alice's Office Phone”
<sips:1234@10.0.0.20>;q=1;expires=3600;+sip.avaya.shared-
control;+sip.avaya.shared-control.protocol=avaya.endpoint.xml

A controlling application that subscribes to the registration event package reads the user preferred label from the reg event NOTIFY messages. Where there are multiple endpoints registered on behalf of a user, the user may create a shared control session where the endpoint will collect the user preferred labels of the controllable endpoints from the reginfo notification and present them to an end user. The controlling application will provide the user to select the device desired to control through the shared control mechanism. An example of a SIP reg event notification sent by a Registrar as a result of a registration event subscription done by a user's endpoints (telephones or softclients):

<?xml version=“1.0”?>
<reginfo xmlns=“urn:ietf:params:xml:ns:reginfo”
xmlns:xsi=“http://www.w3.org/2001/XMLSchema-instance”
version=“0” state=“full”>
<registration aor=“sip:1234@avaya.com” id=“a991” state=“active”>
<contact id=“c991-2093531819--2065507332-1” state=“active”
event=“registered” duration-registered=“1” q=“1.0”>
<uri>sips:1234@10.0.0.20</uri>
<display-name>Alice's Office Phone</display-name>
<unknown-param name=“+sip.avaya.shared-control”></unknown-param>
<unknown-param name=“+sip.avaya.shared-
control.protocol”>avaya.endpoint.xml</unknown-param>
</contact>
</registration>
</reginfo>

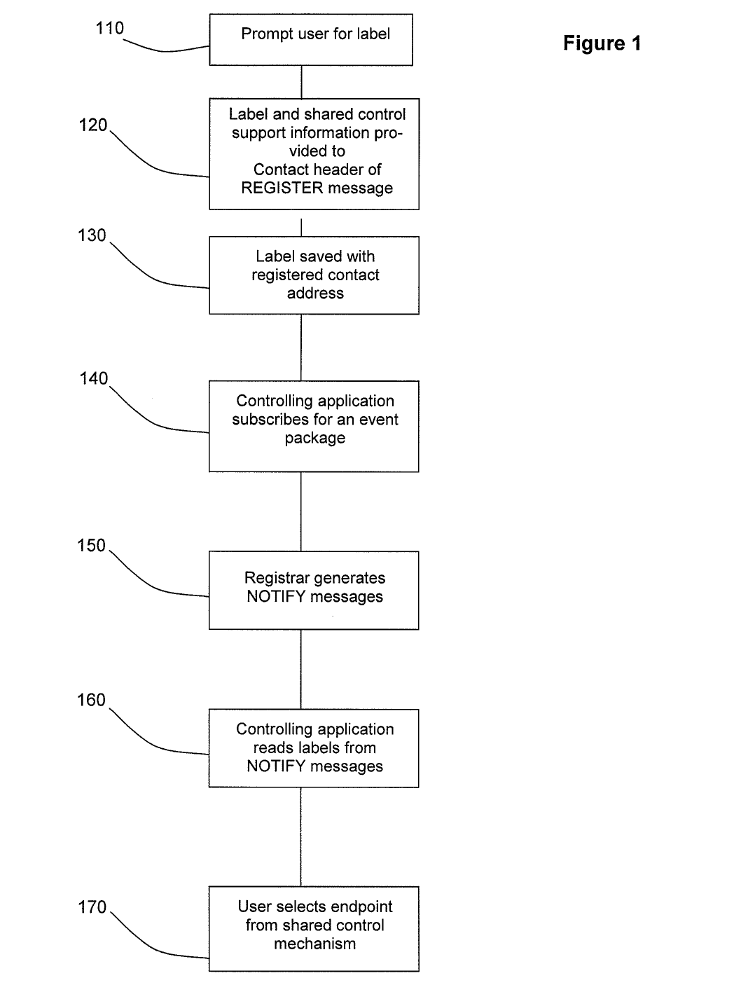

FIG. 1 shows a method of providing for controllable devices through SIP shared control mechanism. In a first process a user is prompted for a label 110. In a second process, the provided label is next provided in a contact header of a REGISTER message 120. An indication about ability to support shared control and which shared control protocol can be supported are also provided. In a third process 130, the label, and the shared control support indication and the shared control protocol, is saved with a registered contact address. The next process 140 shows the controlling application subscribing for an event package. The next process 150 shows the Registrar generating a NOTIFY message. Next, in process 160, the controlling application will read the labels, and the shared control support indication and the shared control protocol, from the NOTIFY message. Finally, the user will select the desired endpoint from a shared control mechanism to establish a shared control session.

In variation of the invention, no provisioning of user preferred labels is required. A controlling application will send a shared control INVITE request with a Request-URI set to a user's AOR. The INVITE request will include information that this is an invitation request for a shared control session. The proxy server receiving this will look up the list of registered contacts on behalf of the user (AOR) and select the one(s) that are capable of supporting the shared control protocol indicated in the INVITE request. The proxy server will then fork the request to all controllable endpoints of the user (AOR) that support the shared control protocol indicated in the INVITE request. Accordingly, all of the end user controllable endpoints will provide alerts about an incoming shared control request. The user will pick up the shared control request at the endpoint they would like to use to control the call.

In another variation of the invention, the controlling application—based on the information received in a SIP reg event notification—detects which of the registered controllable devices are compatible for a shared control session. The controlling application sends a separate INVITE request for each controllable device that is deemed compatible. In this case, the Request-URI of each INVITE request sent by the controlling application uniquely identifies a registered controllable device and the INVITE request is routed by the proxy server using normal SIP message routing logic. Those skilled in the art will understand the application of normal SIP message routing logic and its application to the current embodiments of the invention.

When there are multiple controllable devices alerting, the user will need to accept the shared control session at the device they wish to control through the controlling application (e.g., softclient). When there is a single controllable device matching the requested shared control protocol indicated in the INVITE request, the controllable endpoint may automatically accept the INVITE, avoiding the extra step user needs to take in answering the call. This automatic acceptance of the incoming shared control session request is performable by embodiments of the invention when the controlled endpoints also subscribe for registration event notification, and know the exact number of SIP endpoints that can match the shared control protocol criteria indicated in the INVITE request.

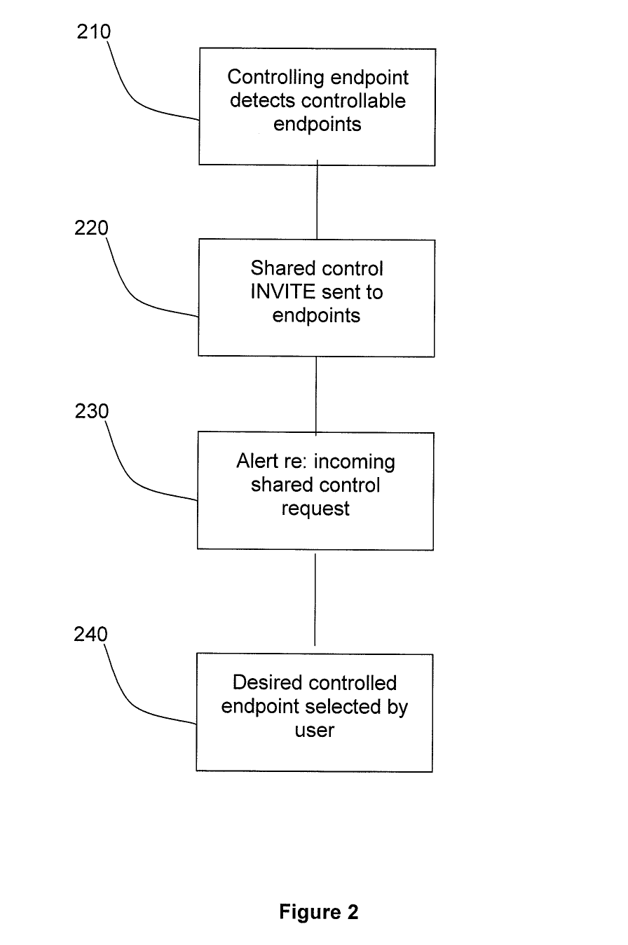

FIG. 2 shows controlling endpoint and multiple controllable endpoint interaction. In the first process 210 a controlling endpoint will detect the controllable endpoints. As noted above in this description, this is one way for the controlling endpoint to implement embodiments of the invention. In other implementations of embodiments, the proxy will fork the INVITE request based on its detection of controllable endpoints. In the second process 220 a shared control INVITE message is sent to the detected endpoints. In the third process 230, the user of the controllable endpoints is alerted as to the incoming shared control request. In the fourth process 240, the user will select the desired controlled endpoint.

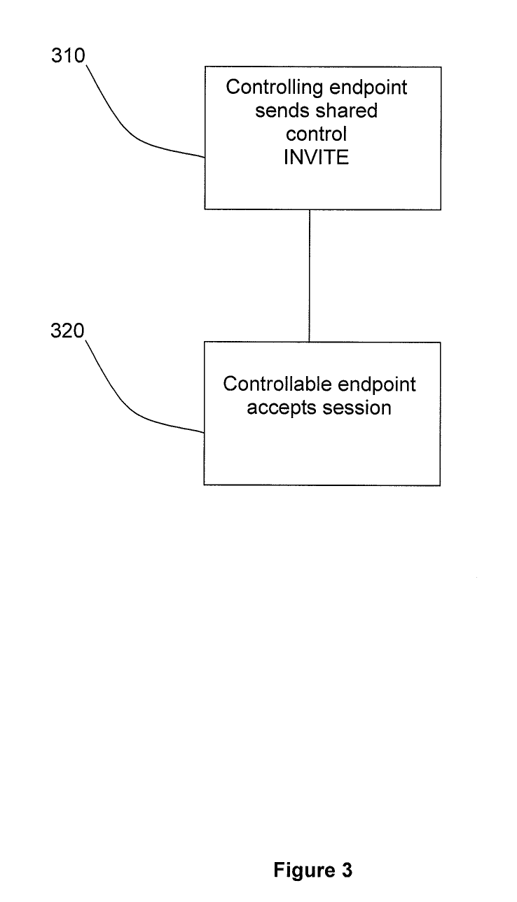

FIG. 3 shows controlling endpoint and single controllable endpoint interaction. In a first process 310, a controlling endpoint will send a shared control INVITE to a controllable endpoint. In the next process 320, the controllable endpoint will automatically accept the incoming shared control session. As noted above, for this variation of the embodiment to work properly, the Request-URI of each INVITE request sent by the controlling application will uniquely identify a registered controllable device and the INVITE request will be routed by the proxy server using normal SIP message routing logic.

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for establishing a session initiation protocol shared control channel between a first endpoint and a plurality of second endpoints associated with a user, said method comprising:
providing a label and shared control support information corresponding to each of said plurality of second endpoints in a Contact header of a REGISTER message to a session initiation protocol registrar;
saving each of said labels and shared control support information in association with a registered contact address of said second endpoint;
via said first endpoint, reading each of said labels and shared control support information from a registration event NOTIFY message; and
creating a shared control session and presenting said labels of said plurality of second endpoints to said user enabling said user to select one of said plurality of endpoints.

2. The method of claim 1, wherein said first endpoint is a controlling endpoint.

3. The method of claim 1, wherein said plurality of second endpoints are a plurality of controllable endpoints.

4. The method of claim 1, wherein said first endpoint is a softclient application.

5. The method of claim 1, said method further comprising, via said first endpoint, subscribing for a registration event package.

6. A method for establishing a session initiation protocol shared control channel between a first endpoint and a plurality of second endpoints associated with a user, said method comprising:
sending a shared control INVITE request with a Request-URI set to an address of record of a user, said INVITE request comprising an indication of a desired protocol for said shared control session;
by a proxy server. Receiving said INVITE request;
by said proxy server, determining a list of registered contacts associated with said address of record;
by said proxy server, selecting from said list one or more of said contacts that support indicated shared control protocol; and
by said proxy server, forking said INVITE request to said selected contacts.

7. A method for establishing a session initiation protocol shared control channel between a controlling application and an endpoint, said endpoint comprising one of a plurality of controllable devices, said method comprising:
at said controlling application, receiving a session initiation protocol registration event notification;
at said controlling application, detecting which or one or more registered controllable devices are compatible for a shared control session;
sending a separate INVITE request for each controllable device that is deemed compatible; and
at said endpoint, enabling control by a user of said endpoint.

8. The method of claim 7, said method further comprising:
presenting a list of controllable devices to said user.

9. The method of claim 7, wherein a Request-URI of each of said separate INVITE requests uniquely identifies a registered controllable device and said INVITE request is routed by said proxy server using session initiation protocol routing logic.

10. A system for establishing a session initiation protocol shared control channel, said system comprising:
a controlling endpoint; and
a plurality of controlled endpoints associated with an end user;
wherein said controlling endpoint is enabled to subscribe to a registration event package, read labels corresponding to said plurality of controlled endpoints from a registration event NOTIFY message, and present said labels to the end user in connection with a shared control SIP session.

11. The system of claim 10, wherein said controlling endpoint is a softclient.

12. The system of claim 10, said wherein each of said plurality of controlled endpoints are enabled to prompt said user for entry of a label and provide said label in a display name portion of a Contact header of a REGISTER message to an SIP registrar.
